(19) United States
(12) Patent Application Publication
(10) Pub. No.: US 2020/0347884 A1
(43) Pub. Date: Nov. 5, 2020

(54) SEAL ASSEMBLY DEVICE AND SEAL ASSEMBLY METHOD

(71) Applicant: JTEKT CORPORATION, Osaka-shi, Osaka (JP)

(72) Inventors: Kenichi MORITA, Kitakatsuragi-gun (JP); Daisuke YAMASAKI, Osaka-shi (JP); Mitsuru SAWANO, Yao-shi (JP); Takafumi UEMOTO, Kashiwara-shi (JP)

(73) Assignee: JTEKT CORPORATION, Osaka-shi, Osaka (JP)

(21) Appl. No.: 16/962,870

(22) PCT Filed: Jan. 31, 2019
(86) PCT No.: PCT/JP2019/003278

§ 371 Date: Jul. 17, 2020

(30) Foreign Application Priority Data
Feb. 1, 2018 (JP) 2018-016529

(51) Int. Cl. F16C 33/76; F16C 19/18

(52) U.S. Cl. CPC F16C 33/76; F16C 2326/02; F16C 19/18

(57) ABSTRACT

A seal assembly device is configured to attach an annular seal by press-fitting to an axial end portion of a first raceway member of a wheel bearing device. The seal assembly device includes: a columnar guide member including a contact surface configured to contact a plurality of rolling elements provided along a raceway surface formed on the first raceway member from a side opposite to the raceway surface, the contact surface being continuous in a circumferential direction; a pressing member configured to move in an axial direction along the guide member toward the axial end portion so as to press the seal in the axial direction and to press-fit the seal into the axial end portion; and a reference member configured to restrict a movement stroke of the pressing member with respect to the guide member in the axial direction.

### TECHNICAL FIELD

Aspects of the present invention relate to a seal assembly device and a seal assembly method.

### BACKGROUND ART

In a vehicle such as an automobile, a wheel bearing device (hub unit) is used to support a wheel. The wheel bearing device includes an outer ring member (first raceway member), an inner shaft member (second raceway member), and a plurality of rolling elements arranged between the outer ring member and the inner shaft member. A seal is attached to the outer ring member to prevent foreign matter from entering a gap between the outer ring member and the inner shaft member (inside a bearing where the rolling elements are provided) from the outside on one axial direction side where the wheel is attached. The seal includes a rubber lip. The lip is in contact with a seal surface of the inner shaft member. Patent Literature 1 discloses a vehicle bearing device in related art.

### CITATION LIST

### Patent Literature

Patent Literature 1: JP-A-2007-224941

### SUMMARY OF THE INVENTION

### Technical Problem

FIG. 6 is a cross-sectional view of an outer ring member and a seal. A seal 91 is attached by press-fitting to an end portion 98 of one side in an axial direction (hereinafter, referred to as “outer ring end portion 98”) of an outer ring member 99. At the time of attachment, a position of the seal 91 is managed with reference to an end surface 97 of the outer ring end portion 98 (hereinafter, referred to as “first end surface 97”). When the attachment position of the seal 91 varies, interference of a lip 92 with respect to a seal surface 93 indicated by alternate long and two short dashes lines in FIG. 6 varies. When the interference of the lip 92 varies, a tightening force of the lip 92 against the seal surface 93 is not constant for each product, and sealing performance thereof becomes uneven. Moreover, torque (sliding friction torque) generated when the lip 92 comes into contact with the seal surface 93 is not constant.

Here, the interference (tightening force) of the lip 92 with respect to the seal surface 93 is greatly affected by a relative position between the outer ring member 99 and an inner shaft member 94 in an axial direction. Therefore, a ball 95 interposed between the outer ring member 99 and the inner shaft member 94 may be used as a reference to manage the attachment position of the seal 91 with respect to the ball 95.

However, in the related art, the attachment of the seal 91 is performed with reference to the first end surface 97 as described above. In this case, a variation in a relative position (dimension La in FIG. 6) between the ball 95 and the seal 91 in the axial direction is increased due to the following elements 1 to 3.
Element 1: Variations caused by a manufacturing error of an axial dimension Lb of the outer ring member 99.
Element 2: Variations in an axial position of an outer raceway surface 96 on an inner peripheral side of the outer ring member 99 (dimension Lc).
Element 3: A position of the press-fitting of the seal 91 performed with reference to the first end surface 97 of the outer ring end portion 98 (dimension Ld).

That is, the axial dimension Lb of Element 1 is a distance between the first end surface 97 and an end surface 100 located on an opposite side thereof in the axial direction (hereinafter, referred to as “second end surface 100”). Polishing of the first end surface 97 is performed with reference to the second end surface 100. Further, polishing of the outer raceway surface 96 of Element 2 is performed with reference to the second end surface 100. Therefore, even if the press-fitting of the seal 91 is performed correctly with reference to the first end surface 97, that is, even if there is no error in the dimension Ld of Element 3, variations occur in the relative position between the ball 95 and the seal 91 (dimension La of FIG. 6) in the axial direction when manufacturing errors occur in the position of the first end surface 97 (Element 1) and the position of the outer raceway surface 96 (Element 2) with respect to the second end surface 100. In some cases, the above-mentioned errors may be accumulated to increase such variations. As a result, the interference of the lip 92 with respect to the seal surface 93 varies.

Therefore, an object of aspects of the present invention is to provide a seal assembly device capable of attaching a seal to an axial end portion of an outer ring member with rolling elements serving as a reference to reduce variations in interference of a lip of the seal with respect to a seal surface, and an assembly method performed by the assembly device.

### Means for Solving the Problem

An aspect of the invention provides a seal assembly device for attaching a seal having an annular shape by press-fitting to an axial end portion of a first raceway member of a wheel bearing device. The seal assembly device includes: a guide member having a columnar shape and including a contact surface configured to contact a plurality of rolling elements provided along a raceway surface formed on the first raceway member from a side opposite to the raceway surface, the contact surface being continuous in a circumferential direction; a pressing member configured to move in an axial direction along the guide member toward the axial end portion so as to press the seal in the axial direction and to press-fit the seal into the axial end portion; and a reference member configured to restrict a movement stroke of the pressing member with respect to the guide member in the axial direction.

According to the assembly device, the contact surface of the guide member is brought into contact with the plurality of rolling elements provided along the raceway surface from the side opposite to the raceway surface so as to prevent relative displacement between the first raceway member, the rolling elements, and the guide member. The pressing member is moved in the axial direction along the guide member toward the axial end portion of the first raceway member so as to press the seal by the pressing member and press-fit the seal to the axial end portion. At this time, according to the reference member, the pressing member is moved in the axial direction for a predetermined movement stroke with respect to the guide member. Therefore, the seal can be attached to the axial end portion of the first raceway member with the rolling elements provided along the raceway surface of the first raceway member serving as the reference.

It is preferable that the contact surface have a specification the same as that of a raceway surface formed on a second raceway member of the wheel bearing device and configured to contact with the rolling elements. According to such a configuration, a state where the rolling elements are interposed between the first raceway member and the second raceway member of the wheel bearing device is simulated through using the guide member of the assembly device.

It is preferable that the plurality of rolling elements be balls, and the guide member include, in addition to the contact surface, a cylindrical guide surface to be disposed in proximity to a radially inner side of the balls provided along the raceway surface. According to such a configuration, the guide member, the balls, and the first raceway member are aligned.

It is preferable that the reference member include a reference surface which is capable of pushing the pressing member toward the first raceway member and contacting an axial end surface of the guide member, the axial end surface being located on a side opposite to a side on which the contact surface is provided, and the movement stroke be a stroke from where the reference member starts to push the pressing member to where the reference member is no longer capable of pushing the pressing member as the reference surface comes into contact with the axial end surface. In this case, when the reference member pushes the pressing member and the reference surface of the reference member comes into contact with the axial end surface of the guide member, the seal is attached to a predetermined position at the axial end portion of the first raceway member.

A seal assembly method of attaching a seal having an annular shape by press-fitting to an axial end portion of a first raceway member of a wheel bearing device, the seal assembly method includes: a preparing process of arranging a plurality of rolling elements along a raceway surface formed on the first raceway member; a fixing process of bringing a contact surface of a guide member into contact with the plurality of rolling elements from a side opposite to the raceway surface so as to prevent relative displacement between the first raceway member, the rolling elements, and the guide member; and a press-fitting process of moving a pressing member in an axial direction along the guide member toward the axial end portion so as to press the seal by the pressing member and press-fit the seal to the axial end portion. In the press-fitting process, the pressing member is moved for a predetermined stroke with respect to the guide member in the axial direction.

According to such an assembly method, the seal can be attached to the axial end portion of the first raceway member with the rolling elements, which is in contact with the raceway surface of the first raceway member, serving as a reference. Moreover, the assembly method is performed by the above-mentioned assembly device, for example.

### Advantageous Effects of Invention

According to the aspects of the present invention, the seal can be attached to the axial end portion of the first raceway member with the rolling elements serving as the reference.

### BRIEF DESCRIPTION OF DRAWINGS

FIG. 1 is a cross-sectional view showing an example of a wheel bearing device.

FIG. 2 is a cross-sectional view showing an assembly device (preparing process).

FIG. 3 is a cross-sectional view showing the assembly device (fixing process).

FIG. 4 is a cross-sectional view showing the assembly device (press-fitting process).

FIG. 5 is a cross-sectional view showing the assembly device (press-fitting process).

FIG. 6 is a cross-sectional view of an outer ring member and a seal.

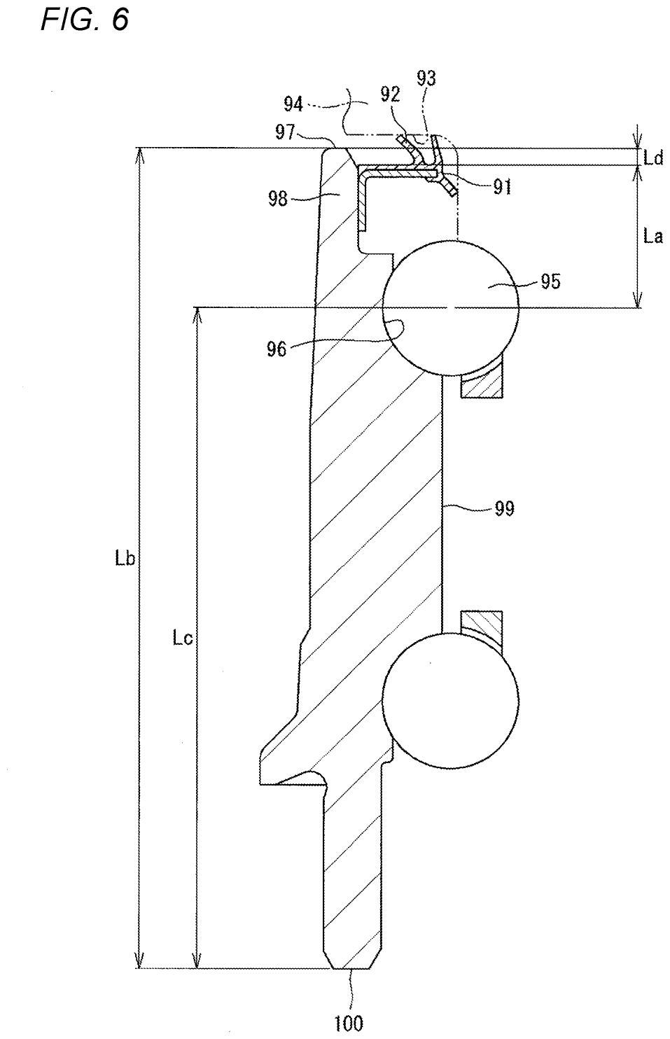

### MODE FOR CARRYING OUT THE INVENTION

[Configuration of Wheel Bearing Device]

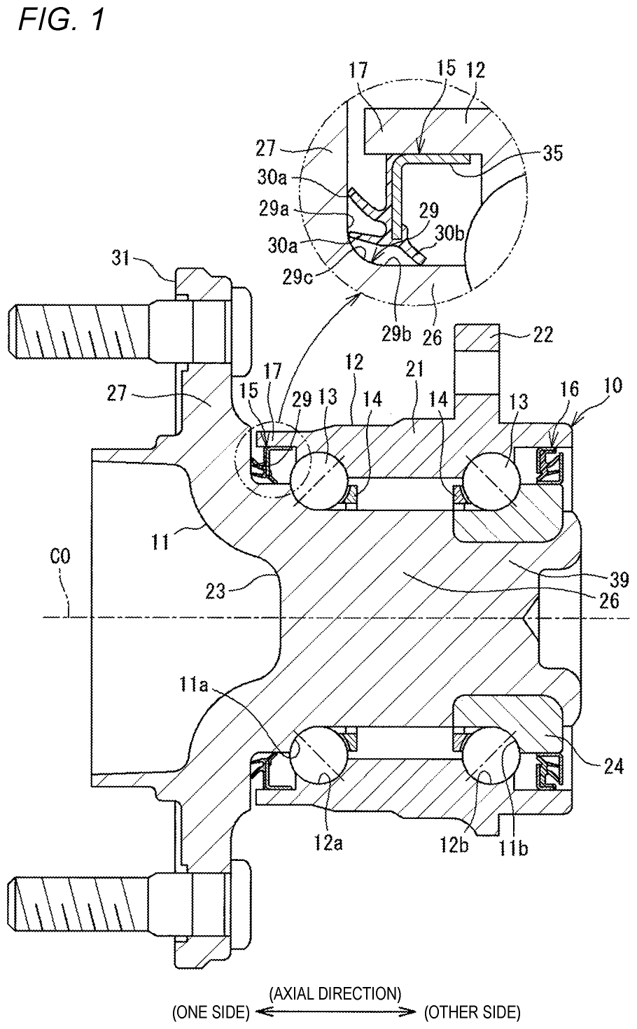

FIG. 1 is a cross-sectional view showing an example of a wheel bearing device. A wheel bearing device (hub unit) 10 is attached to a suspension (knuckle) provided on a vehicle body side of an automobile to rotatably support a wheel. The wheel bearing device 10 includes: an outer ring member 12 which serves as a first raceway member; an inner shaft member 11 which serves as a second raceway member; balls 13 which serves as rolling elements; a cage 14; a first seal 15 provided on one axial direction side; and a second seal 16 provided on the other axial direction side. An axial direction of the wheel bearing device 10 refers to a direction parallel to a central axis C0 of the wheel bearing device 10 (hereinafter, referred to as the bearing central axis C0). A radial direction refers to a direction orthogonal to the axial direction.

The outer ring member 12 includes: an outer ring body portion 21 which has a cylindrical shape; and a fixing flange portion 22 which extends radially outward from the outer ring body portion 21. Outer raceway surfaces 12a, 12b are formed on an inner peripheral side of the outer ring body portion 21. The outer ring member 12 is attached to a knuckle (not shown), which is a vehicle body side member, by the flange portion 22. As a result, the wheel bearing device 10 including the outer ring member 12 is fixed to a vehicle body. In a state where the wheel bearing device 10 is fixed to the vehicle body, the side of a wheel attachment flange portion 27 of the inner shaft member 11 to be described below is the outside of the vehicle. That is, the one axial direction side where the flange portion 27 is provided is a vehicle outer side, and the other axial direction side, which is an opposite side thereof, is a vehicle inner side.

The inner shaft member 11 includes: a hub shaft (inner shaft) 23; and an inner ring 24 which is attached to the other axial direction side of the hub shaft 23. The hub shaft 23 includes: a shaft body portion 26 which is provided on a radial direction inner side of the outer ring member 12; and the flange portion 27 which is provided on the one axial direction side of the shaft body portion 26. The shaft body portion 26 is a shaft portion that is elongated in the axial direction. The flange portion 27 extends radially outward from the one axial direction side of the shaft body portion 26. A wheel and a brake rotor (not shown) are attached to a surface (flange surface) 31 located on the one axial direction side of the flange portion 27. A seal surface 29 is provided between the shaft body portion 26 and the flange portion 27.

The inner ring 24 is an annular member and is externally fitted and fixed to a small diameter portion 39 located on the other axial direction side of the shaft body portion 26. A (first) inner raceway surface 11a is formed on an outer peripheral surface of the shaft body portion 26, and a (second) inner raceway surface 11b is formed on an outer peripheral surface of the inner ring 24.

A plurality of balls 13 are arranged between the outer raceway surface 12a and the inner raceway surface 11a on the one axial direction side. A plurality of balls 13 are arranged between the outer raceway surface 12b and the inner raceway surface 11b on the other axial direction side. The balls 13 are arranged in two rows between the outer ring member 12 and the inner shaft member 11. Each of the outer raceway surfaces 12a, 12b and the inner raceway surfaces 11a, 11b has a concave arc-shaped cross section. The balls 13 are in point contact with the outer raceway surfaces 12a, 12b and the inner raceway surfaces 11a, 11b with contact angles.

The first seal 15 is attached to one axial direction side end portion 17 (hereinafter, referred to as “outer ring end portion 17”) of the outer ring member 12. In FIG. 1, as shown in an enlarged view, the first seal 15 includes a metal mandrel 35 and rubber lips 30a, 30b which are fixed to the mandrel 35. On the side of the inner shaft member 11, the seal surface 29 includes an annular seal surface 29a, a cylindrical seal surface 29b, and an R surface 29c. The annular seal surface 29a is in contact with the lip 30a which extends toward the flange portion 27 of the seal 15. The cylindrical seal surface 29b faces the lip 30b which extends toward the shaft body portion 26 of the seal 15. The annular seal surface 29a is along a surface orthogonal to the bearing central axis C0 as a whole. The cylindrical seal surface 29b is along a cylindrical surface parallel to the bearing central axis C0 as a whole. The R surface 29c connects the annular seal surface 29a and the cylindrical seal surface 29b. The first seal 15 prevents foreign matter, such as muddy water, from entering a bearing where the balls 13 are provided from a gap between the outer ring member 12 and the inner shaft member 11 on the one axial direction side. The second seal 16 prevents foreign matter, such as muddy water, from entering the bearing from a gap between the outer ring member 12 and the inner shaft member 11 on the other axial direction side.

[Assembly Device 40]

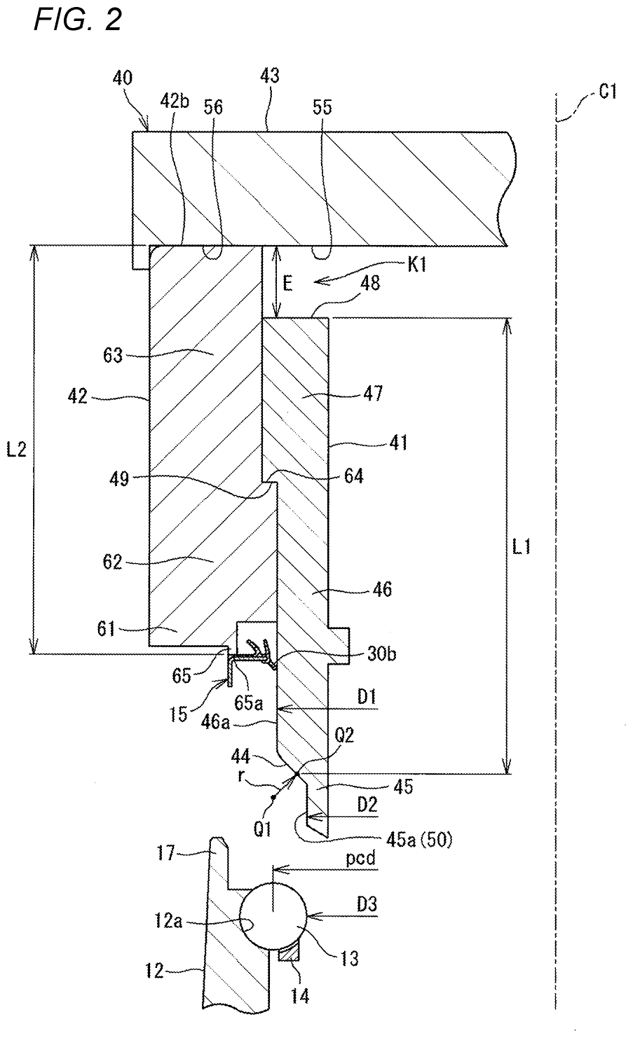

FIG. 2 is a cross-sectional view showing an assembly device 40 for press-fitting and attaching the annular first seal 15 (hereinafter, simply referred to as “seal 15”) to the outer ring end portion 17. The assembly device 40 includes a guide member 41, a pressing member 42, and a reference member 43.

A posture of the outer ring member 12 and the assembly device 40 when the seal 15 is attached to the outer ring end portion 17 will be described. In the present embodiment, the seal 15 is attached to the outer ring end portion 17 in a state where the outer ring member 12 is in the posture shown in FIG. 2. That is, the attachment is performed in a state where central axes of the outer ring member 12 and the seal 15 coincide with a vertical direction. In the assembly device 40, central axes of the guide member 41, the pressing member 42, and the reference member 43 are the same. The attachment is performed with such a central axis (central axis of the assembly device 40) and the central axes of the outer ring member 12 and the seal 15 positioned on the same reference line C1. When the seal 15 is attached, the outer ring member 12 is placed on a workbench (not shown). The plurality of balls 13 are provided along the outer raceway surface 12a on the one axial direction side of the outer ring member 12. The balls 13 are held by the cage 14 at intervals in a circumferential direction. The seal 15 is attached by press-fitting to the outer ring end portion 17 in such a state.

A configuration of each portion of the assembly device 40 will be described. The guide member 41 is a column member, and has a linear cylindrical shape in the present embodiment. The guide member 41 includes a small diameter portion 45, a medium diameter portion 46, and a large diameter portion 47 in order from a lower side. The small diameter portion 45 has a smaller outer diameter than that of the medium diameter portion 46. The medium diameter portion 46 has a smaller outer diameter than that of the large diameter portion 47. The large diameter portion 47 includes an axial end surface 48 on an upper end thereof. The axial end surface 48 is a surface orthogonal to the central axis (the reference line C1) of the guide member 41. An annular stepped surface 49 is provided between the large diameter portion 47 and the medium diameter portion 46.

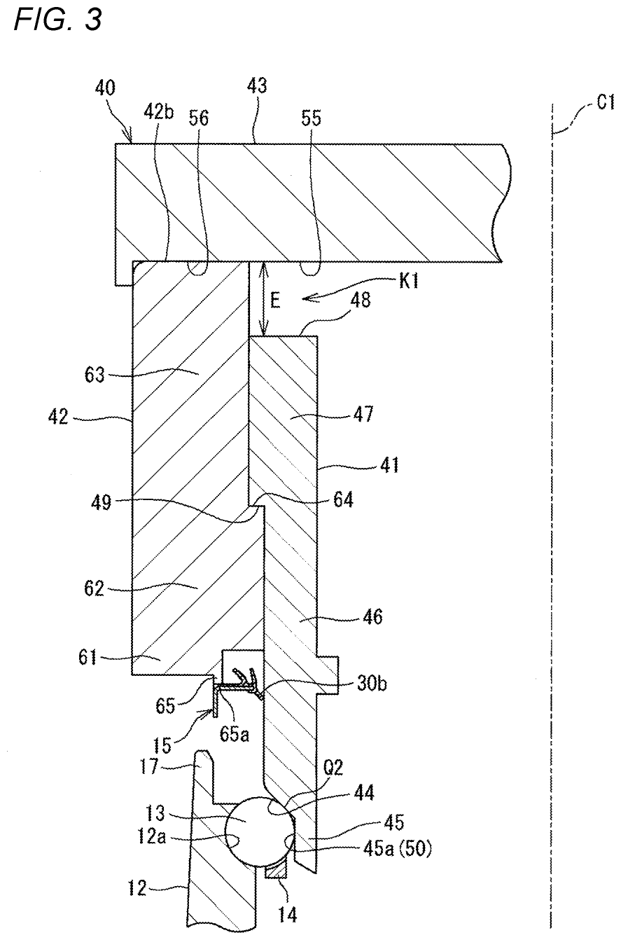

A diameter D1 of an outer peripheral surface 46a of the medium diameter portion 46 is substantially the same as a pitch circle diameter (pcd) of the plurality of balls 13 provided along the outer raceway surface 12a. A diameter D2 of an outer peripheral surface 45a of the small diameter portion 45 is smaller than the pitch circle diameter (pcd) of the balls 13. The medium diameter portion 46 includes a contact surface 44 that is continuous in the circumferential direction on the side of the small diameter portion 45. The contact surface 44 of the present embodiment is a tapered surface. Therefore, the contact surface 44 can contact the plurality of balls 13 provided along the outer raceway surface 12a over an entire periphery (see FIG. 3). When the contact surface 44 is in contact with all of the plurality of balls 13, the guide member 41 cannot move downward in the axial direction and is positioned in the axial direction.

The contact surface 44 has the same specifications as those of the inner raceway surface 11a of the inner shaft member 11 of the wheel bearing device 10 shown in FIG. 1. Such specifications at least include: the pitch circle diameter (pcd) of the ball 13 to be contacted (see FIG. 2) and a distance r from a point Q1 on a pitch circle of the ball 13 to be contacted to a contact point Q2 of the ball 13. The actual inner raceway surface 11a has a concave arc-shaped cross section as described above. The above-mentioned distance r is a curvature radius of the inner raceway surface 11a.

In this way, the guide member 41 includes the contact surface 44 which is a surface continuous in the circumferential direction. As shown in FIG. 3, the contact surface 44 is in contact with the plurality of balls 13 provided along the outer raceway surface 12a from a side opposite to the outer raceway surface 12a.

An axial direction dimension L1 of the guide member 41 from a contact position of the contact surface 44 with the ball 13 (contact point Q2) to the axial end surface 48, which is a surface opposite to a side where the contact surface 44 is provided in the axial direction, is set to a predetermined value. The contact surface 44 and the axial end surface 48 are machined (for example, polished) to improve accuracy of the axial direction dimension L1.

The small diameter portion 45 of the guide member 41 further includes a cylindrical guide surface 50, which can contact the balls 13, on an outer peripheral side. In the present embodiment, the guide surface 50 is constituted by the outer peripheral surface 45a of the small diameter portion 45. The diameter D2 of the guide surface 50 is slightly smaller than a diameter D3 of an inscribed circle of the plurality of balls 13 provided along the outer raceway surface 12a. Therefore, as shown in FIG. 3, the guide surface 50 is provided in close proximity to the plurality of balls 13 provided along the outer raceway surface 12a on a radial direction inner side.

In FIG. 2, the pressing member 42 is a linear cylindrical member that is externally fitted to the guide member 41 (the large diameter portion 47 and the medium diameter portion 46) with a gap therebetween. In the present embodiment, the pressing member 42 and the reference member 43 are separate members, and are coupled to and integrated with each other by a coupling portion (not shown). The pressing member 42 is movable along the guide member 41 (in a linear direction of the reference line C1).

The pressing member 42 includes (in order from a lower side): a first cylindrical portion 61 which has a large (largest) inner diameter; a second cylindrical portion 62 which has a smallest inner diameter; and a third cylindrical portion 63 which has a larger inner diameter than that of the second cylindrical portion 62. An annular receiving surface 64 is provided between the second cylindrical portion 62 and the third cylindrical portion. The stepped surface 49 of the guide member 41 can contact the receiving surface 64. When the stepped surface 49 is in contact with the receiving surface 64, the guide member 41 is suspended from the pressing member 42. The guide member 41 and the pressing member 42 are relatively movable in the axial direction between the receiving surface 64 and a reference surface 55 of the reference member 43. The seal 15 attached to the outer ring end portion 17 is held by a holding mechanism (not shown) at an axial end portion (first cylindrical portion 61) of the pressing member 42. An inner diameter of the seal 15 (inner diameter of the lip 30b) is larger than the diameter D1 of the outer peripheral surface 46a of the medium diameter portion 46 of the guide member 41 in a state where the seal 15 is held at the axial end portion (first cylindrical portion 61) of the pressing member 42.

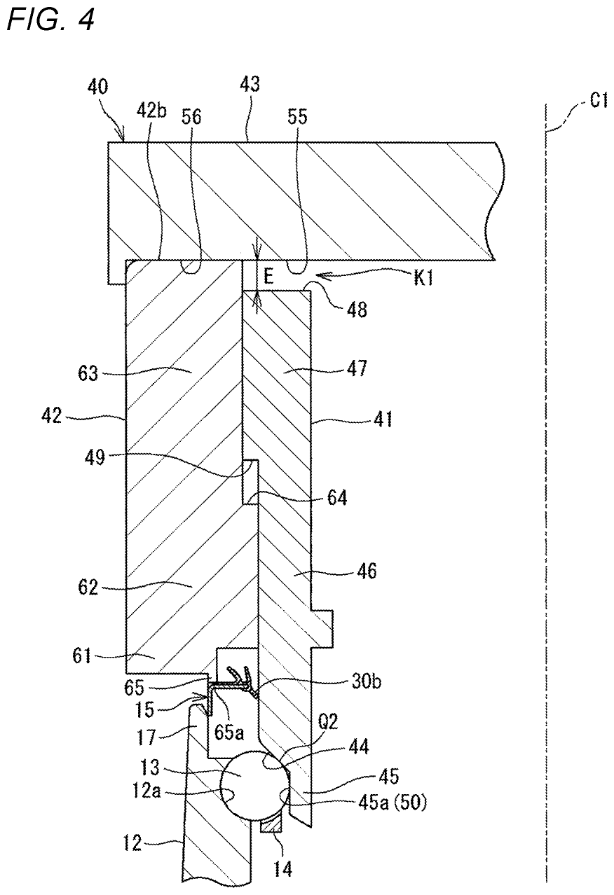

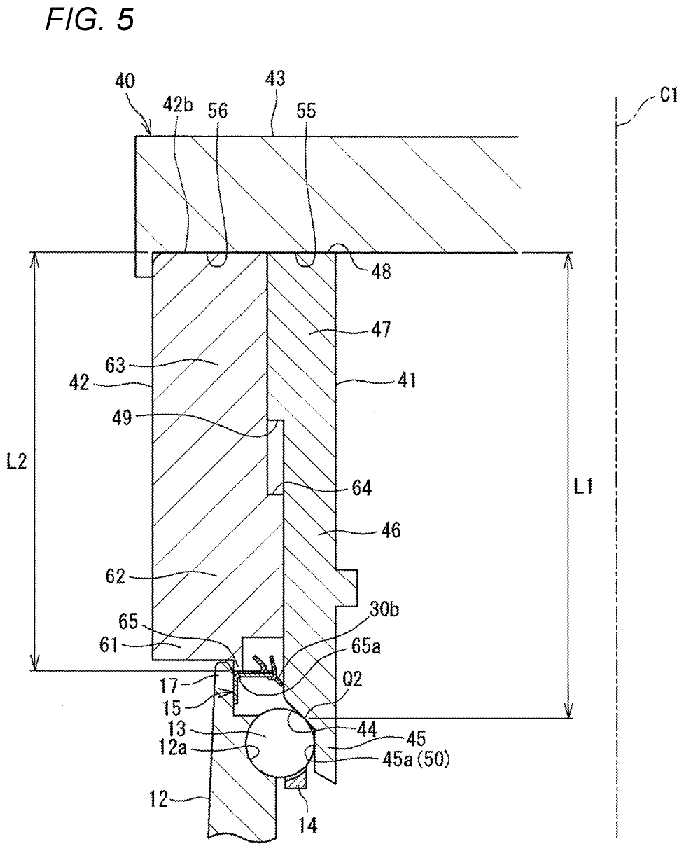

The pressing member 42 (first cylindrical portion 61) includes an annular pressing portion 65 at an axial end portion thereof (lower end). The pressing portion 65 is in contact with the seal 15 in the axial direction and presses the seal 15 in the axial direction. When the pressing portion 65 presses the seal 15 in the axial direction (downward in the present embodiment), as shown in FIGS. 4 and 5, the seal 15 is press-fitted into the outer ring end portion 17. FIG. 4 shows a start state where the seal 15 starts to be press-fitted into the outer ring end portion 17. FIG. 5 shows a completed state where the press-fitting of the seal 15 with respect to the outer ring end portion 17 is completed. The seal 15 is fixed at a position where the press-fitting is completed. In this way, by moving the pressing member 42 in the axial direction along the guide member 41 toward the outer ring end portion 17, the seal 15 can be pressed in the axial direction and press-fitted into the outer ring end portion 17.

In FIG. 2, an axial direction dimension L2 from an axial end surface (upper surface) 42b of the pressing member 42 to a tip end surface 65a of the pressing portion 65 is set to a predetermined value. The axial end surface 42b and the tip end surface 65a are machined (for example, polished) to improve accuracy of the axial direction dimension L2.

The reference member 43 is a disk-shaped member. The reference member 43 can be moved by an actuator (not shown) linearly along the reference line C1 (movable in an up-down direction in the present embodiment). The reference member 43 includes the reference surface 55 and a pressing surface 56 on a lower surface side thereof. The pressing surface 56 contacts and presses the axial end surface 42b of the pressing member 42. Due to the pressing, as shown in FIGS. 4 and 5, the seal 15 is press-fitted into the outer ring end portion 17.

When the reference member 43 is lowered by the actuator, as shown in FIG. 5, the reference surface 55 comes into contact with the axial end surface 48 of the guide member 41. When the reference surface 55 comes into contact with the axial end surface 48, the reference member 43 cannot move further in the axial direction (downward). At this point, movement (lowering) of the reference member 43 performed by the actuator is stopped. For example, when the reference member 43 is no longer movable, since a load of the actuator increases, a load detection sensor of the actuator detects the increase, and an operation of the actuator is stopped.

The reference surface 55 and the pressing surface 56 are both machined (for example, polished) to improve runout accuracy or the like with reference to the reference line C1. Although the pressing surface 56 and the reference surface 55 are provided on a common plane in the present embodiment, the two surfaces may also be provided on different planes.

In this way, the reference member 43 can push the pressing member 42 toward the outer ring member 12. The reference member 43 includes the reference surface 55. The reference surface 55 can contact the axial end surface 48 located on the side opposite to the side where the contact surface 44 of the guide member 41 is provided.

[Assembly Method]

A method of assembling the seal 15 by the assembly device 40 having the above configuration will be described. Such an assembly method includes a preparing process (see FIG. 2), a fixing process (see FIG. 3), and a press-fitting process (see FIGS. 4 and 5). The preparing process, the fixing process, and the press-fitting process are performed in this order.

[Preparing Process]

In the preparing process, as shown in FIG. 2, the plurality of balls 13 are arranged along the outer raceway surface 12a of the outer ring member 12. The plurality of balls 13 are held by the cage 14. The outer ring member 12 is placed on the workbench with the central axis thereof provided along the vertical direction. Such a state is referred to as a first state.

[Fixing Process]

The reference member 43 is lowered together with the guide member 41 and the pressing member 42 from the first state. As shown in FIG. 3, the contact surface 44 of the guide member 41 is brought into contact with the balls 13 (second state). At this time, the guide surface 50 of the guide member 41 is guided to the plurality of balls 13, the plurality of balls 13 are guided to the guide surface 50, and the guide member 41, the plurality of balls 13, and the outer ring member 12 are thus aligned. In the second state, the contact surface 44 is in contact with the plurality of balls 13. In the second state, the contact surface 44 may be in contact with all the balls 13, or may be in contact with a part of (a plurality of) the balls 13 in the circumferential direction. Then the plurality of balls 13 are pressed by the contact surface 44 to come into contact with the outer raceway surface 12a. As a result, the guide member 41 can no longer move downward in the axial direction, and is positioned in the axial direction. The guide member 41 is also positioned in the radial direction. In this way, in the fixing process, the contact surface 44 of the guide member 41 is brought into contact with the plurality of balls 13 from the side opposite to the outer raceway surface 12a such that relative displacement between the outer ring member 12, the plurality of balls 13, and the guide member 41 is prevented.

[Press-Fitting Process]

From the first state shown in FIG. 2 to the second state shown in FIG. 3, an axial direction dimension E of a space K1 formed between the reference surface 55 of the reference member 43 and the axial end surface 48 of the guide member 41 does not change (constant). When the reference member 43 is further lowered from the second state, the axial direction dimension E of the space K1 gradually decreases (see FIG. 4). FIG. 4 shows a third state where the reference member 43 pushes down the pressing member 42 and press-fitting of the seal 15 into the outer ring end portion 17 is started by the pressing member 42. When the reference member 43 is further lowered from the third state, the pressing member 42 moves along the guide member 41, and the press-fitting of the seal 15 is performed by the pressing member 42. In this way, in the press-fitting process, by moving the pressing member 42 in the axial direction along the guide member 41 toward the outer ring end portion 17, the seal 15 is pressed by the pressing member 42 and press-fitted into the outer ring end portion 17.

When the reference member 43 is lowered from the third state shown in FIG. 4, as shown in FIG. 5, the reference surface 55 and the axial end surface 48 come into contact with each other, and the axial direction dimension E of the space K1 becomes zero. Such a state is a fourth state. When the reference surface 55 and the axial end surface 48 come into contact with each other, the reference member 43 can no longer move toward the outer ring end portion 17. Therefore, movement of the pressing member 42, which is moved integrally with the reference member 43 with respect to the guide member 41, is stopped. In this way, a movement stroke of the pressing member 42 with respect to the guide member 41 in the axial direction is restricted by the reference member 43. Such a movement stroke has a value up to a value which makes the axial direction dimension E of the space K1 become zero. That is, in the press-fitting process, the pressing member 42 is moved by the predetermined stroke (value up to the value that makes the direction dimension E become zero) with respect to the guide member 41 in the axial direction.

The movement stroke of the pressing member 42 restricted by the reference member 43 will be further described. Such a movement stroke is a stroke from where the reference member 43 presses the pressing member 42 (from the third state shown in FIG. 4) to where the reference surface 55 comes into contact with the axial end surface 48 such that the reference member 43 can no longer press the pressing member 42 as shown in FIG. 5. More specifically, the movement stroke is a stroke from where the reference member 43 presses the pressing member 42 to start the press-fitting of the seal 15 performed by the pressing member 42 (from the third state shown in FIG. 4) to where the reference surface 55 comes into contact with the axial end surface 48 such that the reference member 43 can no longer press the pressing member 42 as shown in FIG. 5.

A position of the seal 15, which is press-fitted into the outer ring end portion 17 by the press-fitting process, is a predetermined press-fitting position. As described above, the axial direction dimension L1 of the guide member 41 from the contact position of the contact surface 44 with the ball 13 (contact point Q2) to the axial end surface 48 is set to the predetermined value. Moreover, the axial direction dimension L2 from the axial end surface (upper surface) 42b of the pressing member 42 to the tip end surface 65a of the pressing portion 65 is set to the predetermined value. Therefore, according to the assembly device 40 of the present embodiment, the seal 15 is attached to the predetermined position of the outer ring end portion 17 with reference to the ball 13 which is in contact with the outer raceway surface 12a.

The accuracy of the axial direction dimension L1 and the axial direction dimension L2 is improved as described above. Therefore, with reference to the ball 13 which is in contact with the outer raceway surface 12a, the seal 15 is attached to the outer ring end portion 17 at an accurate position. It should be noted that the pressing member 42 is in a non-contact state with the outer ring end portion 17 in the fourth state.

[Assembly Device 40 of the Present Embodiment]

According to the assembly device 40 having the above configuration, the contact surface 44 of the guide member 41 is in contact with the plurality of balls 13 provided along the outer raceway surface 12a of the outer ring member 12 from the side opposite to the outer raceway surface 12a (see FIG. 3). As a result, the relative displacement between the outer ring member 12, the balls 13, and the guide member 41 is prevented. The pressing member 42 is moved in the axial direction along the guide member 41 toward the outer ring end portion 17 (see FIGS. 4 and 5). Then the seal 15 is pressed by the pressing member 42 and press-fitted into the outer ring end portion 17. At this time, according to the reference member 43, the pressing member 42 is moved in the axial direction for the predetermined movement stroke with respect to the guide member 41. Therefore, the seal 15 can be attached to the outer ring end portion 17 with the balls 13 provided along the outer raceway surface 12a serving as a reference.

In the fourth state shown in FIG. 5, the reference member 43 presses the guide member 41 toward the balls 13. Therefore, an assembly completed state where the balls 13 are interposed between the outer ring member 12 and the inner shaft member 11 of the wheel bearing device 10 (see FIG. 1) is simulated in the assembly device 40. In the assembly device 40, each ball 13 has a predetermined angle (contact angle) with respect to a surface orthogonal to the reference line C1, and is in contact with the outer raceway surface 12a and the contact surface 44. Therefore, an axial direction dimension from the seal 15 (lip 30a) to the seal surface 29 (see FIG. 1) is a predetermined value. According to the assembly device 40, an attachment position of the seal 15 is constant for each product with reference to the balls 13.

In this way, when the outer ring member 12 where the seal 15 is attached is combined with the inner shaft member 11, the axial direction dimension from the seal 15 (lip 30a) to the seal surface 29 (see FIG. 1) becomes the predetermined value. As a result, variations in interference of the lip 30a with respect to the seal surface 29 are reduced. Therefore, a tightening force of the lip 30a against the seal surface 29 is constant for each product, and sealing performance becomes uniform. Moreover, torque (sliding friction torque) generated when the lip 30a comes into contact with the seal surface 29 is constant. By setting the torque to be small, loss caused by friction can be reduced.

In the present embodiment, as described above, the contact surface 44 of the guide member 41 has the same specifications as those of the inner raceway surface 11a which is formed on the outer peripheral side of the inner shaft member 11 shown in FIG. 1 and is in contact with the balls 13. Therefore, the state where the balls 13 are interposed between the outer ring member 12 and the inner shaft member 11 of the wheel bearing device 10 is simulated through using the guide member 41 of the assembly device 40. As a result, the seal 15 can be more accurately attached to the outer ring end portion 17.

Since the contact surface 44 of the guide member 41 has the same specifications as those of the inner raceway surface 11a, although not shown, the guide member 41 may have a divided structure, and the inner ring 24 (obtained by additionally processing the inner ring 24) may be used as a portion of the guide member 41. In this case, however, the first inner raceway surface 11a and the second inner raceway surface 11b need to have the same specifications.

The guide member 41 may be configured by a plurality of divided bodies divided in the circumferential direction. In this case, the contact surface 44 which is continuous in the circumferential direction of the guide member 41 is configured by combining the divided bodies.

The embodiment disclosed herein is provided to exemplify the invention in every point and is not intended to restrict the invention. The scope of the present invention is not limited to the embodiment described above, and all modifications within the scope equivalent to the configurations described in the claims are included. The rolling elements provided between the inner shaft member 11 and the outer ring member 12 may be other than the balls 13, and may be rollers (tapered rollers). The wheel bearing device where the seal 15 is assembled by the assembly device 40 of the present embodiment may be other than that shown in FIG. 1. For example, although not shown, the invention can also be applied to a wheel bearing device where the wheel and the brake rotor are attached to the outer ring member 12 and the inner shaft member 11 is attached to the vehicle body side.

This application is based on Japanese Patent Application No. 2018-016529 filed on Feb. 1, 2018, the contents of which are incorporated herein by reference.

### DESCRIPTION OF REFERENCE SIGNS

10: wheel bearing device

11: inner shaft member (second raceway member)

11a: inner raceway surface

12: outer ring member (first raceway member)

12a: outer raceway surface (raceway surface)

13: ball (rolling element)

15: seal

17: end portion (outer ring end portion)

41: guide member

42: pressing member

43: reference member

44: contact surface

48: axial end surface

50: guide surface

55: reference surface

1. A seal assembly device for attaching a seal having an annular shape by press-fitting to an axial end portion of a first raceway member of a wheel bearing device, the seal assembly device comprising:
a guide member having a columnar shape and comprising a contact surface configured to contact a plurality of rolling elements provided along a raceway surface formed on the first raceway member from a side opposite to the raceway surface, the contact surface being continuous in a circumferential direction;
a pressing member configured to move in an axial direction along the guide member toward the axial end portion so as to press the seal in the axial direction and to press-fit the seal into the axial end portion; and
a reference member configured to restrict a movement stroke of the pressing member with respect to the guide member in the axial direction.

2. The seal assembly device according to claim 1,
wherein the contact surface has a specification the same as that of a raceway surface formed on a second raceway member of the wheel bearing device and configured to contact with the rolling elements.

3. The seal assembly device according to claim 1,
wherein the plurality of rolling elements are balls, and
wherein the guide member comprises, in addition to the contact surface, a cylindrical guide surface to be disposed in proximity to a radially inner side of the balls provided along the raceway surface.

4. The seal assembly device according to claim 1,
wherein the reference member comprises a reference surface which is capable of pushing the pressing member toward the first raceway member and contacting an axial end surface of the guide member, the axial end surface being located on a side opposite to a side on which the contact surface is provided, and
wherein the movement stroke is a stroke from where the reference member starts to push the pressing member to where the reference member is no longer capable of pushing the pressing member as the reference surface comes into contact with the axial end surface.

5. A seal assembly method of attaching a seal having an annular shape by press-fitting to an axial end portion of a first raceway member of a wheel bearing device, the seal assembly method comprising:
arranging a plurality of rolling elements along a raceway surface formed on the first raceway member;
bringing a contact surface of a guide member into contact with the plurality of rolling elements from a side opposite to the raceway surface so as to prevent relative displacement between the first raceway member, the rolling elements, and the guide member; and
moving a pressing member in an axial direction along the guide member toward the axial end portion so as to press the seal by the pressing member and press-fit the seal to the axial end portion, the pressing member being moved for a predetermined stroke with respect to the guide member in the axial direction.
